(19) United States
(12) Patent Application Publication
(10) Pub. No.: US 2024/0251997 A1
(43) Pub. Date: Aug. 1, 2024

(54) DOUBLE-ENDED SPATULA

(71) Applicants: Randall Ryon, Victor, NY (US); Alan Ryon, Rochester, NY (US); Robert Ryon, Palmyra, NY (US)

(72) Inventors: Randall Ryon, Victor, NY (US); Alan Ryon, Rochester, NY (US); Robert Ryon, Palmyra, NY (US)

(21) Appl. No.: 18/418,220

(22) Filed: Jan. 20, 2024

Related U.S. Application Data
(60) Provisional application No. 63/441,806, filed on Jan. 29, 2023.

(51) Int. Cl. A47J 43/28

(52) U.S. Cl. CPC A47J 43/288

(57) ABSTRACT

The present invention is a cooking utensil comprising, a body, wherein the body is comprised of a first section, a second section, and a third section, wherein a first bend of a predetermined radius is between the first section and the section, and a second bend of a predetermined radius is between the second section and the third section.

### CROSS-REFERENCE TO RELATED APPLICATIONS

This application is a continuation-in-part (and claims the benefit of priority under 35 USC 120) of U.S. provisional application No. 63/441,806 filed Jan. 29, 2023. The disclosure of the prior applications is considered part of (and is incorporated by reference in) the disclosure of this application.

### BACKGROUND OF THE INVENTION

The present invention relates to a spatula, and more particularly to a double ended spatula.

Spatulas are routinely used in food preparation in home and commercial kitchens. A typical spatula includes a handle and an adjoined blade or head. Spatulas are used for a variety of diverse functions, with the specific functions of a particular spatula dictating the exact shape of the head. For example, spatulas may be used to spread soft foods, such as mayonnaise. Such spatulas typically have a head with at least one curved edge. Other spatulas are used when cooking in a skillet (e.g., flipping pancakes or scrambling eggs). These spatulas have heads with flat front edges for scraping. Still other spatulas may be used to mix ingredients in a mixing bowl. Such mixing spatulas are typically flexible, bending when mixing ingredients and returning to their original shape thereafter.

Prior to some cooking operations, many of the individual ingredients are stored in bottles or jars. Thus, as the ingredients are combined into a bowl to be mixed, each ingredient must first be removed from its jar. Oftentimes the tasks of removing the food from jars and mixing are carried out using the same spatula. The shape of the spatula, however, often precludes the spatula from removing all of the ingredients in the jar. For example, many jars have curved rims connecting the jar opening to the inside walls of the jar. Many spatulas have straight handles connected to straight heads. This straight shape precludes the spatula from removing ingredients from under the rim of the jar.

However, these spatulas do not work well when used in a deep pan or dish to remove or serve the content of the pan due to the design of the handle and the spatula head. The shape and contour make it difficult to easily get around the deep sides of the pan and getting the spatula underneath the food, or to clean the 90-degree corner of the pan.

It is desired to have a spatula that is able to work easily on deep pans when serving and cleaning.

### SUMMARY

In a first embodiment, the present invention is a cooking utensil comprising, a body, wherein the body is comprised of a first section, a second section, and a third section, wherein a first bend of a predetermined radius is between the first section and the section, and a second bend of a predetermined radius is between the second section and the third section.

In a second embodiment, the present invention is a cooking utensil comprising: a body, wherein the body is comprised of a first section, a second section, and a third section, wherein a first bend of a predetermined radius is between the first section and the section, and a second bend of a predetermined radius is between the second section and the third section; and a cover, wherein the cover is affixed to the first section.

In a third embodiment, the present invention is a cooking utensil comprising: a body, wherein the body is comprised of a first section, a second section, and a third section, wherein a first bend of a predetermined radius is between the first section and the section, and a second bend of a predetermined radius is between the second section and the third section, wherein the third section has a triangular shape, and wherein at least one edge of the third section is serrated.

### BRIEF DESCRIPTION OF THE DRAWINGS

FIG. 1 depicts an isometric view of a double-ended spatula, in accordance with one embodiment of the present invention.

FIG. 2 depicts an isometric view of the double-ended spatula, in accordance with another embodiment of the present invention.

FIG. 3 depicts a section view of the double-ended spatula in use, in accordance with one embodiment of the present invention.

FIG. 4 depicts an isometric view of the double-ended spatula, in accordance with another embodiment of the present invention.

### DETAILED DESCRIPTION OF THE INVENTION

The present invention provides a double ended kitchen tool where either end functions as a handle or as a spatula. The spatula provides an advantage over the present spatulas in allowing two ends to be used in different situations, and overall providing an advantage to work with and in deep pans and dishes. This spatula can act as cutter, scooper, server, scraper, and spreader all in one.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

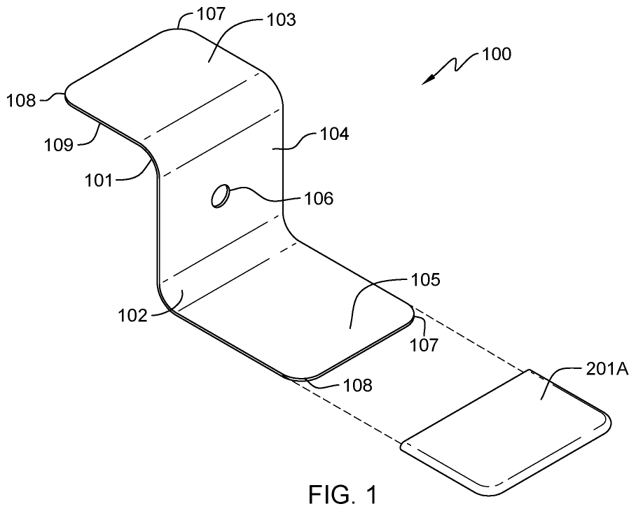

As shown in FIG. 1, the spatula 100 is shown, in accordance with one embodiment of the present invention. The spatula 100 is shown as a single piece having two bends 101 and 102 forming three sections 103, 104, and 105 of the spatula 100. The bends 101 and 102 are of a predetermined radius. In the depicted embodiment, the bends 101 and 102 between the center section and the end sections are approximately 90 degrees. The first end section 103 and the second end section 105 are offset enough by a center section 104 to accommodate working over the edge of a deep pan. The length of each section is of predetermined length based on the pan depth. In the shown embodiment, the two end sections 103 and 105 are of different lengths. The length of the end sections 103 and 105 is based on the intended depth of the pan, while also providing ample length for grabbing and holding on to. The center section 104 acts as a stabilizing corner while carrying food. This center section 104 is of a predetermined length.

In the depicted embodiments, the corners 107 and 108 are rounded. The corners can vary in shape to aide with scraping or spreading and each corner may also have a different contour or design. For example, one corner may be rounded, while another corner may be squared. The width of the spatula 100 is of a predetermined length. In various embodiments each section 103, 104, and 105 may be different widths. The spatula 100 is of a predetermined thickness based on the material the spatula is made from and the intended use. In some embodiments, various edges (e.g. 109) may be designed for cutting and may be serrated. The serrated edge can be wavy, scalloped, saw-toothed, micro, or a combination of these. In some embodiments, the serrated edge is a safety edge, safe for handling.

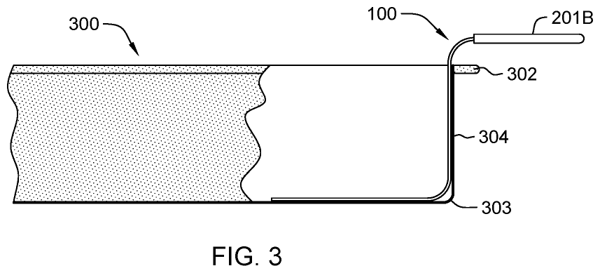

The present design has a center section 104 which is longer than the end section 103 and shorter than the end section 105. This provides for a deep offset to assist with scooping out of a deep pan. The corners have radii which allows for working in deep pans and provide an easy design for cutting and serving food. As shown in FIG. 3, pan 300 is shown in a cutaway view, where the spatula 100 is shown with the center section 104 having a length greater than that of the pan height 304 so that section 105 is able to sit flush against the bottom of the pan 300. Corners 101 and 102 are of an angle so as to not interfere with the corner angle 303 of the pan 300, and the upper edge 302 of the pan. A user would be able to slide the spatula 100 along the side of the pan 300 and cleaning get underneath the food or contents of the pan 300 to easily remove a piece or portion of the food or contents.

The spatula 100 may be made of material such as metal, plastic, wood, or a combination of materials.

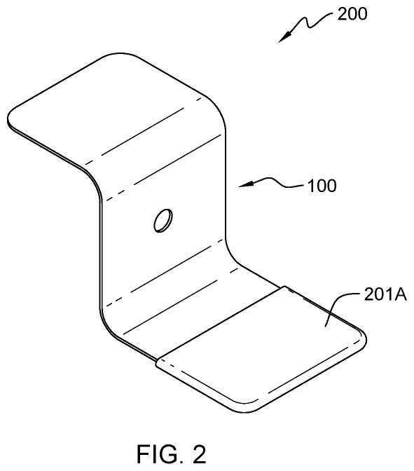

FIG. 2 depicts a spatula 200, in accordance with another embodiment of the present invention. In the depicted embodiment, the spatula 200 has a cover 201A which is attached to the end section 105. The cover 201A may be made from various materials such as silicon, plastic, rubber, or the like to provide additional features of the spatula 200. The shape and contour of the cover 201A may also vary based on the intended design and functionality of the cover 201A. In some embodiments, the cover 201A is permanently affixed to the spatula 200. In other embodiments, the cover 201A is removable or replaceable, as shown in FIG. 1. As shown in FIG. 3, a cover 201B may be attached to section 103. This cover 201B could be used as an insulated cover to protect the user's hand if the spatula or pan are hot.

In the depicted embodiments, the spatula 100 has an aperture 106 in the middle section and would allow for rack hanging at home or in the store. In additional embodiments, the aperture 106 may be positioned in various places and is not limited to the center section 104.

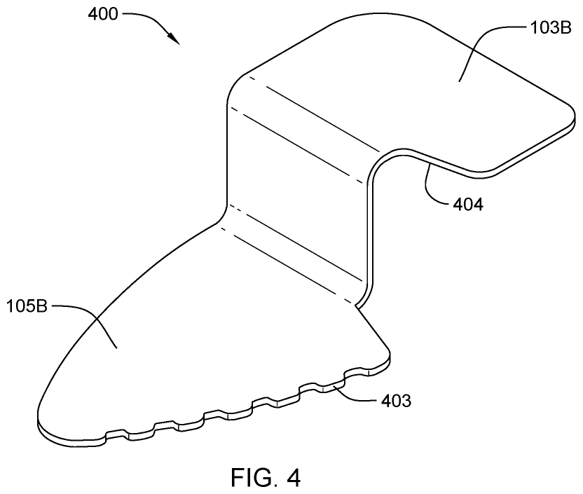

FIG. 4 depicts spatula 400, in accordance with another embodiment of the present invention. As shown, spatula 400 has a modified section 103B and 105B. Where section 105B has a triangular shape with a serrated edge 403. The triangular shape is designed to pick up and serve a typical piece of cake or pie that has a triangular shape. Where the serrated edge 403 is used to assist in cutting the food slices. Section 103B is enlarged with extension 404 to provide a larger surface to grip the spatula 400. The spatula 400 may have various designs and sizes based on the food or content in which the spatula 400 is designed to be used with.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A cooking utensil comprising:
a body, wherein the body is comprised of a first section, a second section, and a third section, wherein a first bend of a predetermined radius is between the first section and the section, and a second bend of a predetermined radius is between the second section and the third section.

2. The cooking utensil of claim 1, wherein the first section, the second section and the third section are all substantially similar lengths.

3. The cooking utensil of claim 1, wherein the first section, the second section and the third section are all substantially similar widths.

4. The cooking utensil of claim 1, wherein the first section, the second section and the third section are all different lengths.

5. The cooking utensil of claim 1, wherein the first section, the second section and the third section are all different widths.

6. The cooking utensil of claim 1, further comprising a cover, wherein the cover is affixed to the third section.

7. The cooking utensil of claim 1, further comprising an aperture on the second section at a predetermined position.

8. The cooking utensil of claim 1, wherein the first and second sections are narrower than the third section.

9. The cooking utensil of claim 1, wherein the third section has a triangular shape

10. The cooking utensil of claim 1, wherein at least one edge of the third section is serrated.

11. A cooking utensil comprising:
a body, wherein the body is comprised of a first section, a second section, and a third section, wherein a first bend of a predetermined radius is between the first section and the section, and a second bend of a predetermined radius is between the second section and the third section; and
a cover, wherein the cover is affixed to the first section.

12. The cooking utensil of claim 11, wherein the first section, the second section and the third section are all substantially similar lengths.

13. The cooking utensil of claim 11, wherein the first section, the second section and the third section are all substantially similar widths.

14. The cooking utensil of claim 11, wherein the first section, the second section and the third section are different lengths.

15. The cooking utensil of claim 11, wherein the first section, the second section and the third section are all different widths.

16. The cooking utensil of claim 11, further comprising an aperture on the second section at a predetermined position.

17. The cooking utensil of claim 11, wherein the first and second sections are narrower than the third section.

18. A cooking utensil comprising:
a body, wherein the body is comprised of a first section, a second section, and a third section, wherein a first bend of a predetermined radius is between the first section and the section, and a second bend of a predetermined radius is between the second section and the third section, wherein the third section has a triangular shape, and wherein at least one edge of the third section is serrated.

19. The cooking utensil of claim 18, further comprising a cover, wherein the cover is secured to the first section.

20. The cooking utensil of claim 18, wherein the first bend and the second bend are substantially the same radius.
